(19) United States
(12) Patent Application Publication
(10) Pub. No.: US 2024/0149662 A1
(43) Pub. Date: May 9, 2024

(54) FIXING DEVICE FOR CONNECTING A FIRST COMPONENT TO A SECOND COMPONENT AND METHOD FOR MAKING A FIXING DEVICE

(71) Applicant: CIKAUTXO, S.COOP., BERRIATUA (ES)

(72) Inventor: Iñaki AZPIAZU ECHAVE, MARKINA - XEMEIN (ES)

(21) Appl. No.: 18/501,158

(22) Filed: Nov. 3, 2023

(30) Foreign Application Priority Data
Nov. 9, 2022 (EP) 22383079.5

(51) Int. Cl. B60K 13/04; F16B 9/00

(52) U.S. Cl. CPC B60K 13/04; F16B 9/07

(57) ABSTRACT

A fixing device for connecting a first component to a second component. The fixing device includes an elastic main body having a connecting area with an inner housing to allow the passage of a securing element of the first component. The securing element has a widened head configured such that, upon passing through the inner housing of the connecting area, it is retained and fixed in the connecting area. The fixing device also includes a reinforcement configured to reinforce the connecting area for the purpose of preventing the removal of the securing element from the fixing device. The reinforcement is arranged on an outer surface of the connecting area such that the reinforcement surrounds the connecting area. The reinforcement being removeable from the elastic main body and not embedded, overmolded, or fixed permanently to the elastic main body.

### CROSS-REFERENCE TO RELATED APPLICATIONS

This application relates to and claims the benefit and priority to European Application No. 22383079.5, filed Nov. 9, 2022.

### FIELD

The present invention relates to fixing devices capable of connecting and fixing a first component to a second component.

### BACKGROUND

Fixing devices capable of fixing a first component to a second component are known. Said fixing devices can, for example, attach a vehicle exhaust pipe (first component) to a vehicle chassis or body (second component). These fixing devices are usually made of rubber to absorb vibrations of the first component, but they must in turn be rigid enough to support the static loads to which said fixing device is subjected, for example, the weight of the first component hanging from the fixing device itself. The fixing device can be fixed to the vehicle in different ways, but the first component is usually hung from the fixing device. In the case where the first component is an exhaust pipe, it usually comprises a securing element, with a widened end, which is inserted into a hole of the fixing device, such that the exhaust pipe is suspended in the vehicle through one or more fixing devices. To prevent the possible detachment of the exhaust pipe from the fixing device, the hole from which the exhaust pipe hangs is often reinforced with an embedded bushing.

In this sense, US20200256239 A1 describes a fixing device which connects an exhaust pipe to a vehicle body. The fixing device comprises an elastic main body comprising a connecting area into which a securing element of the exhaust pipe with a widened head is inserted. The fixing device also comprises a reinforcement which is embedded in the main body and which reinforces the connecting area preventing the removal of the widened head of the securing element of the exhaust pipe.

### SUMMARY

The fixing device of the invention is suitable for fixing a first component, such as an exhaust pipe, to a second component, such as a vehicle body, said fixing device comprising an elastic main body configured to be coupled to the second component, the main body comprising a connecting area comprising an inner housing to allow the passage of a securing element of the first component. The securing element of the first component comprises a widened head which is adapted so that, upon passing through the inner housing of the connecting area, it is retained and fixed in the connecting area. The fixing device further comprises a reinforcement which is adapted to reinforce the connecting area preventing the removal of the widened head of the securing element of the first component. The connecting area also comprises an outer surface surrounding at least part of the inner housing, with the reinforcement being arranged on said outer surface such that the reinforcement surrounds at least part of the inner housing.

The method of the invention comprises a first step wherein the main body comprising the connecting area is obtained by molding, and a second step wherein the reinforcement is arranged on the outer surface of the connecting area.

With the fixing device of the invention, the connecting area in which the securing element of the first component will be housed is reinforced in a simple and versatile manner, allowing the securing element of the first component to be readily inserted into the connecting area pushed by the widened head of the securing element of the first component, while preventing it from being able to be accidentally removed from the inner housing of the connecting area. The reinforcement is not an integral part of the main body, i.e., the reinforcement is not embedded, overmolded, or fixed to the main body permanently, and therefore it is possible to adapt different types of reinforcements (for example, of different sizes or different geometries) to one and the same main body or vice versa, such that the number of references of the stock can be reduced. Furthermore, if it is detected that the reinforcement of the fixing device is not suitable, it would be possible to change said reinforcement without having to discard the main body.

These and other advantages and features will become apparent in view of figures and detailed description.

### BRIEF DESCRIPTION OF THE DRAWINGS

FIG. 1 shows a perspective view of a fixing device according to one embodiment, wherein the main body of the fixing device is overmolded on a rigid connecting element.

FIG. 2 shows a section of the fixing device of FIG. 1.

FIG. 3 shows the sectioned view of FIG. 2 but with the securing element 4 of the first component inserted in the connecting area.

FIG. 4 shows the sectioned view of FIG. 2 but without the reinforcement.

FIG. 5 shows a perspective view of an embodiment of the reinforcement.

FIG. 6 shows a sectioned perspective view of another embodiment of the fixing device according to the invention.

FIG. 7 shows a perspective view of the reinforcement of the fixing device of FIG. 6.

FIG. 8 shows another perspective view of the reinforcement of the fixing device of FIG. 6.

### DETAILED DESCRIPTION

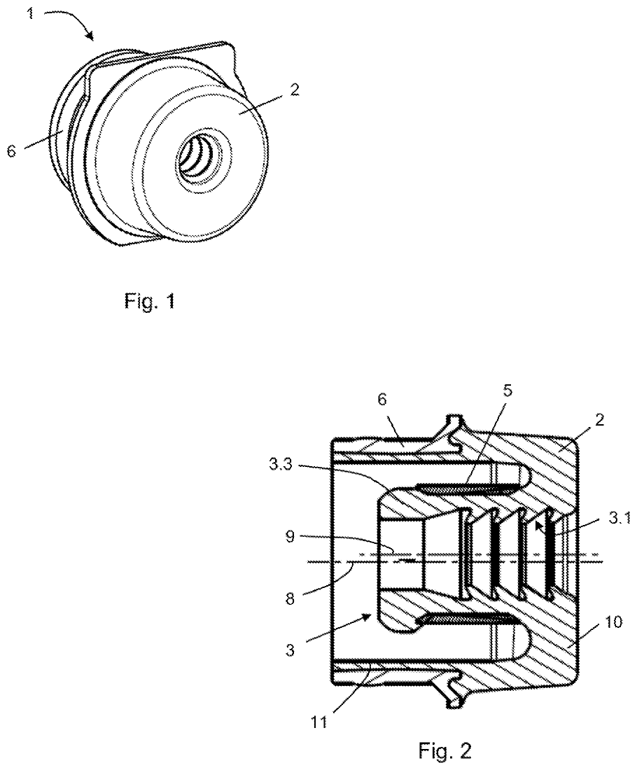

FIGS. 1 and 2 show an embodiment of the fixing device 1 with the fixing device 1 being sectioned in FIG. 2 in order to better understand the invention.

The fixing device 1 of the invention is suitable for attaching a first component, such as an exhaust pipe, to a second component, such as a vehicle body or chassis, said fixing device 1 comprising an elastic main body 2 configured to be coupled to the second component and to the first component, the main body 2 comprising a connecting area 3 comprising an inner housing 3.1 to allow the passage of a securing element 4 of the first component. The securing element 4 of the first component comprises a widened head 4.1 which is adapted so that, upon passing through the inner housing 3.1 of the connecting area 3, it is retained and fixed in the connecting area 3 surrounding the inner housing 3.1, as shown in FIG. 2. The fixing device 1 further comprises a reinforcement 5 which is adapted to reinforce the connecting area 3 in order to prevent the accidental removal of the widened head 4.1 of the securing element 4 of the first component.

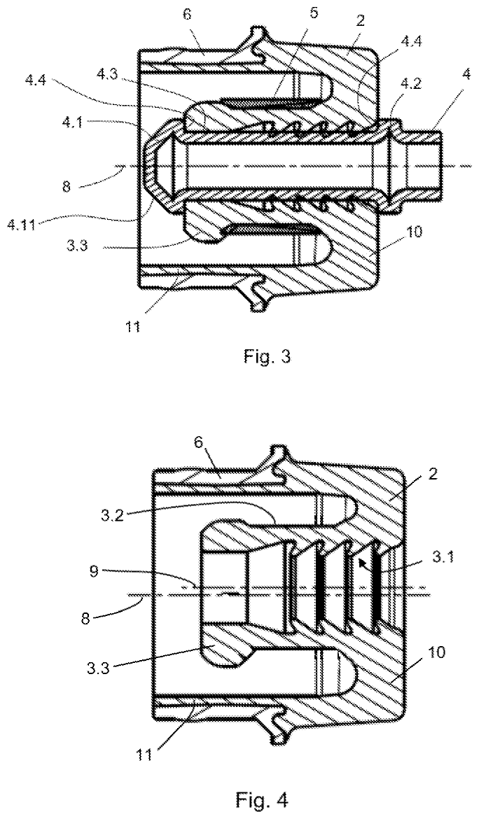

The connecting area 3 also comprises an outer surface 3.2 surrounding at least part of the inner housing 3.1, as can be seen in FIG. 4, and therefore, it is also preferably cylindrical or frustoconical, with the reinforcement 5 being arranged on said outer surface 3.2 such that it surrounds at least part of the inner housing 3.1, as can be seen in FIG. 2 or 3. The reinforcement 5 is not an integral part of the main body 2, and therefore, the reinforcement 5 is not attached to the main body 2 permanently, i.e., the reinforcement 5 is not embedded in the main body 2, nor is the main body 2 overmolded on the reinforcement 5, nor is the reinforcement 5 fixed to the main body 2 in any other way such that it generates a permanent attachment, i.e., the reinforcement 5 is detachable, and therefore the reinforcement 5 could be replaced if need be without damaging the main body 2.

The method of the invention comprises a first step wherein the main body 2 comprising the connecting area 3 is obtained by molding, and a second step wherein the reinforcement 5 is arranged on the outer surface 3.2 of the connecting area 3 once the main body 2 has been cured and removed from the mold.

With the fixing device 1 of the invention, the connecting area 3 in which the securing element 4 of the first component will be housed is reinforced in a simple and versatile manner, allowing the securing element 4 of the first component to be readily inserted into the connecting area 3 pushed by the widened head 4.1 of the securing element 4 of the first component, while preventing it from being able to be accidentally removed from the inner housing 3.1 of the connecting area 3. Since the reinforcement 5 is placed externally and is not an integral part of the main body 2, i.e., the reinforcement 5 is not embedded, overmolded, or fixed to the main body 2 permanently, so it is detachable, it is possible to adapt different types of reinforcements 5 (for example, of different sizes or different geometries) to one and the same main body 2 or vice versa, such that the number of references of the stock can be reduced. Furthermore, if it is detected that the reinforcement 5 of the fixing device 1 is not suitable, it would be possible to change said reinforcement 5 without having to discard the main body 2. Likewise, in the case where the widened head 4.1 of the securing element 4 varies, for example, it would be possible to change the reinforcement 5 in order to adapt it to the new securing element 4, adjusting the rigidity of the reinforcement 5 to its actual usage requirements, for example, without having to discard the main body 2 in this case.

Upon inserting the securing element 4 into the inner housing 3.1 of the connecting area 3, the widened head 4.1 moves forward through said housing 3.1, pushing in its forward movement the material surrounding the connecting area 3, such that the reinforcement 5 expands diametrically without opposing the expansion of the connecting area 3 to allow the passage of the widened head 4.1 of the securing element 4. The widened head 4.1 of the securing element is usually preceded by a chamfer 4.11 which favors the expansion of the connecting area 3 and of the reinforcement 5. However, when the securing element 4 is moved in the opposite direction for its removal, generally by accident (for example, due to an impact), the widened head 4.1, which is retained by the material of the connecting area 3 surrounding the inner housing 3.1, tends to compress the connecting area 3 longitudinally and not to expand it, with the reinforcement 5 in turn opposing in this case the possible accidental expansion of the connecting area 3 to allow the passage of the widened head 4.1, i.e., the reinforcement 5 increases the rigidity of the connecting area 3, and therefore further increases resistance to the passage of the widened head 4.1 of the securing element 4 in the opposite direction (opposite the direction of insertion A).

The fixing device 1 can be fixed to the vehicle in different ways. In the preferred embodiment of the invention, the fixing device 1 of the invention comprises a rigid connecting element 6, as shown in FIGS. 1, 2, 3, and 4, the main body 2 being overmolded on said rigid connecting element 6, such that a permanent attachment is generated between both elements. The rigid connecting element 6 is preferably a rigid plastic, and the main body 2 is made of an elastomer, for example EPDM, silicone (also known internationally as VMQ), natural rubber or thermoplastic. The rigid connecting element 6 may be inserted by pressure into a base support, not shown in the drawings and being preferably metallic, which is in turn fixed to the vehicle body through fixing elements, such as screws or rivets, for example.

In the absence of the rigid connecting element 6, the main body 2 could be overmolded directly on the base support.

In another embodiment not shown in the drawings, the fixing device 1 may comprise a second connecting area to allow the insertion of a securing element, such that a pin, of the vehicle body or chassis (second component). The fixing device 1 would therefore hang from the vehicle chassis (second component), and the exhaust pipe (first component) would hang from the fixing device 1.

The inner housing 3.1 of the connecting area 3 is an opening which is in contact with part of the securing element 4 of the first element when said securing element 4 is inserted into the connecting area 3. Since the connecting area 3 is made of an elastomer, friction between the securing element 4 and the main body 2 is reduced, preventing noise from being generated in said area. In the preferred embodiment of the invention, the opening of the connecting area 3 is a through hole having a preferably circular section, although it could also be elliptical, for example, since the securing elements of exhaust pipes are often cylindrical, generally in the form of a pin, although said hole can have a notched segment to favor the insertion of the securing element 4, as shown in the embodiment shown in FIG. 2, 3, or 4, and/or to reduce the contact area with the securing element 4, thereby reducing the transmission of vibrations from the first component to the second component. In this sense, instead of the notched segment, the through hole may also comprise a segment with at least one protuberance to reduce the contact area with the securing element 4. Both the notched segment and the segment with the protuberance may also contribute to reducing the clearance between the securing element 4 and the through hole, which clearance can be generated as a result of the expansions that both the securing element 4 and the connecting area 3 may experience when the fixing device 1 is in use, thereby preventing the noise that could be generated due to said clearance.

In the non-limiting embodiment of FIG. 2, 3, or 4, the main body 2 comprises a cup-shaped contour, with the connecting area 3 being arranged inside said cup-shaped contour, as can be seen for example in FIG. 4. In other words, the main body 2 comprises a base 10 over which the connecting area 3 extends and a perimeter wall 11 also extending over said base 10 such that the perimeter wall 11 surrounds the connecting area 3 at least partially, as shown in FIG. 2, with the reinforcement 5 being axially retained between the base 10 and a widened retaining segment 3.3 of the connecting area 3, as shown for example in FIGS. 2 and 3. As shown in said figures, the widened retaining segment 3.3 is arranged at the free end of the connecting area 3. Likewise, the reinforcement 5 is arranged on the outer surface 3.2 of the connecting area 3 such that the reinforcement 5 radially adapts to said outer surface 3.2, preventing a radial clearance between both, thereby preventing an undesired axial movement of the reinforcement 5 on the outer surface 3.2 when the fixing device 1 is in use.

The main body 2 comprises an axial axis 8 and the connecting area 3 comprises another axial axis 9, both axes being parallel to one another and to the direction of insertion A of the securing element 4 in the connecting area 3. As shown for example in FIG. 2, the axial axis 9 of the connecting area 3 is off-center with respect to the axial axis 8 of the main body 2 when the securing element 4 of the first component is not inserted into the inner housing 3.1 of the connecting area 3, such that when the securing element 4 of the first component is inserted into the connecting area 3 and hangs from said connecting area 3, the axial axis 9 of the connecting area 3 coincides with the axial axis 8 of the main body 2, i.e., when the first component hangs from connecting area 3, due to the weight of the first component, the connecting area 3 centers itself with respect to the axial axis 8 of the main body 2, as shown in FIG. 3.

The securing element 4 of the first component comprises a retaining ring 4.2, spaced from the widened head 4.1, such that an axial recess 4.3 is generated between the widened head 4.1 and the retaining ring 4.2. Once the securing element 4 is inserted into the inner housing 3.1 of the connecting area 3, the part of the connecting area 3 surrounding the inner housing 3.1 is housed in the axial recess 4.3 of the securing element 4, with the securing element 4 being retained and fixed by means of the material of the connecting area 3 surrounding the inner housing 3.1, as can be seen in FIG. 3. The axial recess 4.3 of the securing element 4 is therefore demarcated by two abutting walls 4.4, one located in the widened head 4.1 and the other in the retaining ring 4.2, as shown in FIG. 3. When the securing element 4 is accidentally moved in a direction opposite the direction of insertion A in order to remove same, the abutting wall 4.4 of the widened head 4.1 axially pushes the connecting area 3 of the main body 2 which cooperates with said abutting wall 4.4, compressing the connecting area 3. In this case, the reinforcement 5 opposes the radial expansion of the connecting area 3, preventing the widened head 4.1 of the securing element 4 from being able to move backwards. However, when inserting the securing element 4 according to the direction of insertion A, the chamfer 4.11 of the widened head 4.1 of the securing element 4, preceding the abutting wall 4.4 in the direction of insertion A, tends to radially expand the material of the connecting area 3 surrounding the inner housing 3.1 during its passage. Therefore, the reinforcement 5 also expands diametrically, from a first position, as the widened head 4.1 moves forward through the connecting area 3, allowing the securing element 4 to be readily inserted. When the widened head 4.1 has gone through the inner housing 3.1 of the connecting area 3 completely, the reinforcement 5 recovers the first position, i.e., the state or position before the insertion of the widened head 4.1, with the connecting area 3 surrounding the inner housing 3.1 being retained in the axial recess 4.3 of the securing element 4 of the first component between the abutting wall 4.4 of the widened head 4.1 and the abutting wall 4.4 of the retaining ring 4.2. The attachment assembly formed by the fixing device 1 and the securing element 4 of the first component is therefore firmly fixed.

The reinforcement 5 of the invention is rigid, for example, it can be made of a thermoplastic material or a thermosetting material or even metal, preferably steel, but is in turn elastic, i.e., it can deform (for example, expand) in order to recover its geometry again.

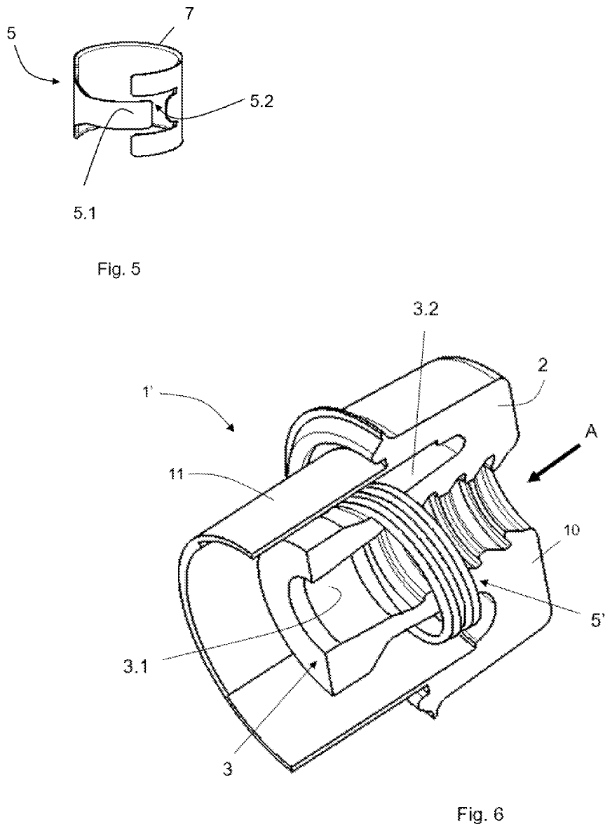

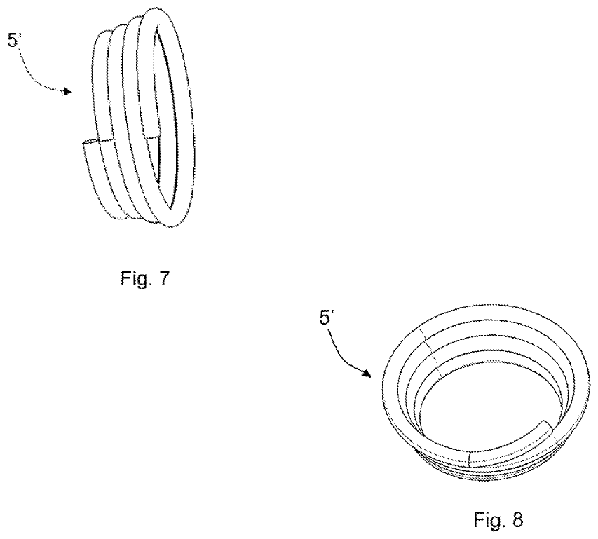

In the preferred embodiment of the invention, the reinforcement 5 is a bushing in the form of a clamp, as shown in FIG. 5, which can expand radially.

As can be seen in the non-limiting example of FIG. 5, the reinforcement 5 comprises a diametrical arm 5.1 at one end and a diametrical recess 5.2 at the other end, with part of the diametrical arm 5.1 being housed in the diametrical recess 5.2. The reinforcement 5 is adapted for, from the first position, expanding diametrically with the end of the diametrical arm 5.1 moving away from the bottom of the diametrical recess 5.2 when the widened head 4.1 of the securing element 4 of the first component is introduced in the inner housing 3.1 of the connecting area 3, and for recovering the first position once the widened head 4.1 has gone through the inner housing 3.1.

In the non-limiting example of FIG. 5, the reinforcement 5 comprises a cylindrical base body 7 which is not completely closed, but covering 360° in diameter. The reinforcement 5 can be extended, as detailed below, a cylindrical body having a larger diameter temporarily being created. The diametrical arm 5.1 is arranged, preferably centered, at one end of said base body 7 with the diametrical arm 5.1 projecting from said end, and the diametrical recess 5.2 is arranged at the other end of the base body 7, with the diametrical recess 5.2 penetrating said end. As shown in FIG. 5, part of the diametrical arm 5.1 is housed in the diametrical recess 5.2, the base body 7 being adapted to expand diametrically altering the first position when the widened head 4.1 of the securing element 4 of the first component is introduced in the inner housing 3.1 of the connecting area 3, and to recover said first position once the widened head 4.1 has gone through the inner housing 3.1, such that the diametrical arm 5.1 moves so as to penetrate or to move away from the bottom of the diametrical recess 5.2. Therefore, as a result of the diametrical arm 5.1 and the diametrical recess 5.2, the base body 7 covers the cylindrical body 360°, although the base body 7 is not closed. In the context of the invention, it is understood that the first position corresponds with the position of the reinforcement 5 when it is arranged in the connecting area 3 but before the securing element 4 has been inserted into the inner housing 3.1 of the connecting area 3.

In another embodiment of the invention, the reinforcement 5′ is a helical spring which can also expand diametrically, the wire of said helical spring being wound such that a preferably cylindrical spring is formed, although it could also be frustoconical. The shape of the reinforcement constitutes the only different feature with respect to the preferred embodiment described.

As can be seen in FIG. 8, the free ends of the helical spring are oriented towards the inside of the spring, thereby preventing sharp edges which may damage the material of the connecting area 3. In other words, at the ends of the spring the natural progression of the cone of the helicoid is altered by orienting said ends towards the inside of the spring, as shown in FIG. 8, such that the ends of the spring do not project from same.

The helical spring of the reinforcement 5′ of this embodiment comprises a wire the diameter of which is in a range of between 1 mm and 2.5 mm, preferably between 1.2 mm and 1.8 mm, said diameter preferably being 1.5 mm. This size allows obtaining a spring that is robust and rigid enough so as to reinforce the connecting area 3, ensuring that the reinforcement 5′ does not deteriorate regardless of the magnitude of the insertion force applied when introducing the securing element 4. The conical shape of the widened head 4.1 of the securing element 4 favors the radial expansion or deformation of the connecting area 3 and of the reinforcement 5′ during the insertion thereof. The helical spring which can have a cylindrical or even frustoconical shape, as described, is formed by winding said wire. A coil is generated in each turn of the wire.

The helical spring comprises at least three coils, comprising preferably four coils, and very preferably six coils. The coils can be supported on one another sequentially, i.e., one coil rests on a contiguous coil, or can be arranged very close to one another, where in this case there is a distance between two consecutive coils of less than four millimeters, preferably less than two millimeters, and more preferably less than one millimeter. This configuration favors the opposition exerted by the reinforcement 5′ against the removal of the widened head 4.1 of the securing element 4 from the connecting area 3, since it increases the rigidity of the reinforcement 5′ when the securing element 4 is to be removed. When the securing element 4 is accidentally moved in the direction opposite the direction of insertion A in order to remove same, the connecting area 3 is compressed, as discussed, such that the helical spring is compacted and becomes more rigid since the coils of the spring tend to come together, complicating the radial expansion thereof, and thereby preventing the widened head 4.1 of the securing element 4 from being able to be moved backwards.

The reinforcement of the invention is coaxial with the inner housing 3.1 of the connecting area 3, as can be seen in the figures.

The concept of the invention also encompasses a motor vehicle comprising a chassis (second component), an exhaust pipe (first component), and the fixing device of the invention described for attaching the exhaust pipe to the chassis. The exhaust pipe (first component) comprises the securing element 4. The main body 2 of the fixing device can be attached to the chassis directly, or through a base support, not shown in the drawings and which is preferably metallic, in which case the main body 2 can be fixed to said base support directly, for example by overmolding the main body 2 on the base support, or through the rigid connecting element 6 which has been described and is preferably made of a rigid plastic, and on which the main body 2 is overmolded.

What is claimed is:

1. A fixing device for connecting a first component to a second component, the fixing device comprising:
an elastic main body configured to be coupled to the second component, the elastic main body including a connecting area having an inner housing with a central axis, the inner housing including an inlet opening and an outlet opening and being configured to receive therein, in a direction of insertion from the inlet opening to the outlet opening, a securing element having a widened head, the connecting area including an end surface outside the inner housing adjacent the outlet opening of the inner housing that is configured to face at least a portion of the widened head, the connecting area including an outer circumferential surface surrounding at least a part of the inner housing; and
a reinforcement arranged on the outer circumferential surface of the connecting area and surrounding the at least part of the inner housing, the reinforcement increasing the rigidity of the connecting area such that upon the securing element extending entirely through the inner housing, the resistance to the passage of the widened head through the inner housing in a direction opposite the direction of insertion is increased.

2. The fixing device according to claim 1, wherein the reinforcement is detachable from the outer circumferential surface of the connecting area.

3. The fixing device according to claim 1, wherein a portion of the connecting area is comprised in a base of the elastic main body, the elastic main body including a perimeter wall protruding in the direction of insertion from the base, the perimeter wall surrounding at least a portion of the connecting area.

4. The fixing device according to claim 1, wherein a free end of the connecting area comprises a widened retaining segment on which a first end of the reinforcement abuts to axially retain the reinforcement in the connecting area.

5. The fixing device according to claim 1, wherein the reinforcement is made of an elastic material and is configured to diametrically expand upon the widened head of the securing element being passed through the inner housing, and to thereafter diametrically contract upon the widened head having exited the outlet opening of the inner housing in the direction of insertion.

6. The fixing device according to claim 5, wherein the reinforcement is a bushing in the form of a clamp which can diametrically expand and thereafter diametrically contract.

7. The fixing device according to claim 6, wherein the reinforcement includes a diametrical arm and a diametrical recess, a part of the diametrical arm being housed in the diametrical recess, the reinforcement being configured to diametrically expand by an end of the diametrical arm moving away from a bottom of the diametrical recess and to diametrically contract by the end of the diametrical arm moving towards the bottom of the diametrical recess.

8. The fixing device according to claim 5, wherein the reinforcement is a helical spring.

9. The fixing device according to claim 8, wherein the helical spring is cylindrical.

10. The fixing device according to claim 8, wherein the helical spring is frustoconical.

11. The fixing device according to claim 8, wherein the helical spring comprises a wire having a diameter in a range of 1 millimeter and 2.5 millimeters.

12. The fixing device according to claim 8, wherein the helical spring comprises a wire having a diameter in a range of 1.2 millimeters and 1.8 millimeters.

13. The fixing device according to claim 8, wherein the helical spring comprises three to six coils and has first and second free ends that are each oriented towards an inside of the helical spring.

14. The fixing device according to claim 8, wherein the helical spring includes a plurality of coils with neighboring coils being spaced-apart from one another by a distance of four millimeter or less.

15. The fixing device according to claim 1, wherein the elastic main body is made of an elastomer and the reinforcement is made of a material selected from the group consisting of a metal, a thermoplastic and a thermosetting material.

16. The fixing device according to claim 1, further comprising the securing element of the first component residing in the inner housing with the end surface of the connecting area outside the inner housing facing the at least portion of the widened head, the securing element including a retaining ring spaced from the widened head such that an axial recess is generated between the widened head and the retaining ring, the inner housing being defined by an inner wall that is housed in the axial recess of the securing element.

17. The fixing device according to claim 16, wherein the elastic main body, reinforcement and securing element are configured such that upon the securing element being moved in an axial direction opposite the direction of insertion, the widened head of the securing element pushes against the end surface of the connecting area and the base of the elastic main body pushes against the retaining ring resulting in the connecting area being axially compressed.

18. The fixing device according to claim 17, wherein the reinforcement is a helical spring that becomes axially compressed upon the connecting area being axially compressed.

19. The fixing device according to claim 1, wherein the first component is an exhaust pipe of a motor vehicle and the second component is a motor vehicle chassis.

20. A motor vehicle comprising:
a chassis;
an exhaust pipe including a securing element having a widened head; and
a fixing device configured to couple the exhaust pipe to the chassis, the fixing device comprising:
an elastic main body configured to be coupled to the securing element of the exhaust pipe, the elastic main body including a connecting area having an inner housing with a central axis, the inner housing including an inlet opening and an outlet opening and being configured to receive therein, in a direction of insertion from the inlet opening to the outlet opening, the widened head of the securing element, the connecting area including an end surface outside the inner housing adjacent the outlet opening of the inner housing that is configured to face at least a portion of the widened head, the connecting area including an outer circumferential surface surrounding at least a part of the inner housing; and
a reinforcement arranged on the outer circumferential surface of the connecting area and surrounding the at least part of the inner housing, the reinforcement increasing the rigidity of the connecting area such that upon the securing element extending entirely through the inner housing, the resistance to the passage of the widened head through the inner housing in a direction opposite the direction of insertion is increased.
